(19) United States
(12) Patent Application Publication
(10) Pub. No.: US 2016/0185896 A1
(43) Pub. Date: Jun. 30, 2016

(54) USE OF 2,5-BIS(AMINOMETHYL)FURAN AS A HARDENER FOR EPOXY RESINS

(71) Applicant: BASF SE, Ludwigshafen (DE)

(72) Inventors: Alexander PANCHENKO, Ludwigshafen (DE); Monika CHARRAK, Ludwigshafen (DE); Kirsten DAHMEN, Bad Duerkheim (DE); Marion BRINKS, Mannheim (DE); Mathias SCHELWIES, Heidelberg (DE); Benoit BLANK, Edingen-Neckarhausen (DE); Markus PIEPENBRINK, Heidelberg (DE); Rene BACKES, Lampertheim (DE); Christian KRAUSCHE, Ruedlingen (CH)

(73) Assignee: BASF SE, Ludwigshafen (DE)

(21) Appl. No.: 14/911,561

(22) PCT Filed: Jul. 29, 2014
(86) PCT No.: PCT/EP2014/066266

§ 371 Date: Feb. 11, 2016

(30) Foreign Application Priority Data
Aug. 12, 2013 (EP) 13180126.8

(51) Int. Cl. C08G 59/50; B05D 5/00; C08G 59/24; C09D 163/00; C08L 63/00

(52) U.S. Cl. CPC C08G 59/5046; C09D 163/00; C08L 63/00; C08G 59/245; B05D 5/00

(57) ABSTRACT

The present invention relates to the use of 2,5-bisaminomethylfuran as hardener for resin components made of epoxy resin and reactive diluent, and also to a corresponding curable composition, curing thereof, and the cured epoxy resin obtainable therefrom. The present invention further relates to the use of 2,5-bisaminomethylfuran as hardener for the production of epoxy-resin-based coatings, in particular of floor coatings with early-stage water resistance.

The present invention relates to the use of 2,5-bisaminomethylfuran (2,5-BAMF) as hardener for resin components made of epoxy resin and reactive diluent, and also to a curable composition which comprises one or more epoxy resins, one or more reactive diluents, and 2,5-BAMF. The invention further relates to the curing of the curable composition, and also to the cured epoxy resin obtained via curing of the curable composition. The invention further also relates to the use of 2,5-BAMF as hardener for the production of epoxy-resin-based coatings having early-stage water resistance, in particular of floor coatings having early-stage water resistance.

Epoxy resins are well known and, because of their toughness, flexibility, adhesion, and chemicals resistance, are used as materials for surface coating, as adhesives, and for molding and lamination, and also for the production of carbon-fiber-reinforced or glassfiber-reinforced composite materials.

Epoxy materials are polyethers and can by way of example be produced via condensation of epichlorohydrin with a diol, for example an aromatic diol such as bisphenol A. These epoxy resins are then cured via reaction with a hardener, typically a polyamine.

Starting from epoxy compounds having at least two epoxy groups it is possible by way of example to use an amino compound having two amino groups for curing via polyaddition reaction (chain extension). High-reactivity amino compounds are generally added only briefly prior to the desired curing. The systems are therefore what are known as 2-component (2C) systems.

In principle, amine hardeners are classified in accordance with their chemical structure into aliphatic, cycloaliphatic, or aromatic types. An additional classification is possible by using the degree of substitution of the amino group, which can be either primary, secondary, or tertiary. However, in the case of the tertiary amines a catalytic mechanism for the curing of epoxy resins is postulated, whereas in the case of the secondary and primary amines the construction of the polymer network is in each case based on stoichiometric curing reactions.

In general terms it has been shown that among the primary amine hardeners it is the aliphatic amines that exhibit the highest epoxy-curing reactivity. The cycloaliphatic amines usually react somewhat more slowly, whereas the aromatic amines (amines where the amino groups have direct bonding to a carbon atom of the aromatic ring) exhibit by far the lowest reactivity.

These known reactivity differences are utilized in the hardening of epoxy resins in order to permit adjustment of the processing time and of the mechanical properties of the hardened epoxy resins in accordance with requirements.

For many applications such as adhesives, RTM applications (resin transfer molding applications), or coatings, in particular floor coatings, there is a need for reactive hardeners which cure and, respectively, have short hardening times even when temperatures are low. Rapid-curing hardeners typically used for such applications are meta-xylylenediamine (MXDA), triethylenetetramine (TETA), or polyetheramines, for example polyetheramine D-230 (difunctional, primary polyetheramine based on polypropylene glycol with average molecular weight 230), or polyetheramine D-400 (difunctional, primary polyetheramine based on polypropylene glycol with average molecular weight 400). Particularly advantageous hardeners for the production of coatings, especially floor coatings (flooring) are polyetheramine D-230 and polyetheramine D-400, because they provide good early-stage water resistance (due to an increased level of hydrophobic properties). However, hardening with these polyetheramines is markedly slower than with TETA or MXDA.

The epoxy resins usually used for the abovementioned applications have high viscosity. That is disadvantageous not only for uniform mixing of the resin with the hardener component but also for the handling of the resultant curable composition (application of a coating or charging to a mold). It is therefore often necessary to add a reactive diluent to the epoxy resin. Reactive diluents are compounds which reduce the viscosity of the epoxy resin, and also the initial viscosity of the curable composition made of resin component and hardener component, and which during the course of the curing of the curable composition enter into chemical bonding with the network as it forms from epoxy resin and hardener. However, the use of reactive diluents also generally disadvantageously reduces the glass transition temperature of the cured epoxy resin. The reduction of initial viscosity of the curable composition by the reactive diluent is also greatly dependent on the hardener used.

GB911221A mentions inter alia the use of 2,5-bisaminomethylfuran as hardener for epoxy resin, but the combination with reactive diluents, or the use for coatings, is not rendered obvious thereby.

For mixtures of epoxy resin and reactive diluent (resin component), it would be desirable to have an amine hardener which simultaneously permit production of a curable composition with comparatively low initial viscosity and provides comparatively rapid hardening. The resultant cured epoxy resin should moreover have good early-stage water resistance.

An object underlying the invention can therefore be considered to be the provision of an amine hardener of this type for mixtures of epoxy resin and reactive diluent and for the use for the production of epoxy-resin-based coatings with early-stage water resistance, in particular floor coatings with early-stage water resistance.

Accordingly, the present invention provides the use of 2,5-bisaminomethylfuran (2,5-BAMF) as hardener for mixtures of epoxy resin and reactive diluent (resin component), and also a curable composition which comprises a resin component and a hardener component, where the resin component comprises one or more epoxy resins and one or more reactive diluents and the hardener component comprises 2,5-BAMF.

For the purposes of the invention, reactive diluents are compounds which reduce the initial viscosity of the curable composition and which, during the course of the curing of the curable composition, enter into chemical bonding with the network as it forms from epoxy resin and hardener. For the purposes of this invention, preferred reactive diluents are low-molecular-weight, organic, preferably aliphatic compounds having one or more epoxy groups, and also cyclic carbonates, in particular cyclic carbonates having from 3 to 10 carbon atoms, for example ethylene carbonate, propylene carbonate, butylene carbonate, or vinylene carbonate.

Reactive diluents of the invention are preferably selected from the group consisting of ethylene carbonate, vinylene carbonate, propylene carbonate, 1,4-butanediol bisglycidyl ether, 1,6-hexanediol bisglycidyl ether (HDBE), glycidyl neodecanoate, glycidyl versatate, 2-ethylhexyl glycidyl ether, neopentyl glycol diglycidyl ether, p-tert-butyl glycidic ether, butyl glycidic ether, C₈-C₁₀-alkyl glycidyl ether, C₁₂-C₁₄-alkyl glycidyl ether, nonylphenyl glycidic ether, p-tert-butyl phenyl glycidic ether, phenyl glycidic ether, o-cresyl glycidic ether, polyoxypropylene glycol diglycidic ether, trimethylolpropane triglycidic ether (TMP), glycerol triglycidic ether, triglycidyl-para-aminophenol (TGPAP), divinylbenzyl dioxide and dicyclopentadiene diepoxide. They are particularly preferably selected from the group consisting of 1,4-butanediol bisglycidyl ether, 1,6-hexanediol bisglycidyl ether (HDBE), 2-ethylhexyl glycidyl ether, C₈-C₁₀-alkyl glycidyl ether, C₁₂-C₁₄-alkyl glycidyl ether, neopentyl glycol diglycidyl ether, p-tert-butyl glycidic ether, butyl glycidic ether, nonylphenyl glycidic ether, p-tert-butylphenyl glycidic ether, phenyl glycidic ether, o-cresyl glycidic ether, trimethylolpropane triglycidic ether (TMP), glycerol triglycidic ether, divinylbenzyl dioxide and dicyclopentadiene diepoxide. They are in particular selected from the group consisting of 1,4-butanediol bisglycidyl ether, C₈-C₁₀-alkyl monoglycidyl ether, C₁₂-C₁₄-alkyl monoglycidyl ether, 1,6-hexanediol bisglycidyl ether (HDBE), neopentyl glycol diglycidyl ether, trimethylolpropane triglycidic ether (TMP), glycerol triglycidic ether, and dicyclopentadiene diepoxide.

In one particular embodiment of the present invention, the reactive diluents are low-molecular-weight organic compounds having two or more, preferably having two, epoxy groups, e.g. 1,4-butanediol bisglycidyl ether, 1,6-hexanediol bisglycidyl ether (HDBE), neopentyl glycol diglycidyl ether, polyoxypropylene glycol diglycidic ether, trimethylolpropane triglycidic ether (TMP), glycerol triglycidic ether, triglycidyl para-aminophenol (TGPAP), divinylbenzyl dioxide, or dicyclopentadiene diepoxide, preferably 1,4-butanediol bisglycidyl ether, 1,6-hexanediol bisglycidyl ether (HDBE), neopentyl glycol diglycidyl ether, trimethylolpropane triglycidic ether (TMP), glycerol triglycidic ether, divinylbenzyl dioxide, or dicyclopentadiene diepoxide, in particular 1,4-butanediol bisglycidyl ether, 1,6-hexanediol bisglycidyl ether (HDBE), neopentyl glycol diglycidyl ether, trimethylolpropane triglycidic ether (TMP), glycerol triglycidic ether, or dicyclopentadiene diepoxide. In one particular embodiment, the reactive diluents are low-molecular-weight aliphatic compounds having two or more, preferably having two, epoxy groups.

In one particular embodiment of the present invention, the reactive diluents are low-molecular-weight organic compounds having an epoxy group, e.g. glycidyl neodecanoate, glycidyl versatate, 2-ethylhexyl glycidyl ether, p-tert-butyl glycidic ether, butyl glycidic ether, C₈-C₁₀-alkyl glycidyl ether, C₁₂-C₁₄-alkyl glycidyl ether, nonylphenyl glycidic ether, p-tert-butylphenyl glycidic ether, phenyl glycidic ether, or o-cresyl glycidic ether, preferably 2-ethylhexyl glycidyl ether, p-tert-butyl glycidic ether, butyl glycidic ether, C₈-C₁₀-alkyl glycidyl ether, C₁₂-C₁₄-alkyl glycidyl ether, nonylphenyl glycidic ether, p-tert-butylphenyl glycidic ether, phenyl glycidic ether, or o-cresyl glycidic ether, in particular C₈-C₁₀-alkyl glycidyl ether, or C₁₂-C₁₄-alkyl glycidyl ether. In one particular embodiment, the reactive diluents are low-molecular-weight aliphatic compounds having an epoxy group.

In one particular embodiment of the present invention, the reactive diluents are cyclic carbonates having from 3 to 10 carbon atoms, for example ethylene carbonate, propylene carbonate, butylene carbonate, or vinylene carbonate, preferably ethylene carbonate, propylene carbonate, or vinylene carbonate.

The reactive diluents of the invention preferably make up a proportion of up to 30% by weight, particularly up to 25% by weight, in particular from 1 to 20% by weight, based on the resin component (epoxy resin and any reactive diluents used) of the curable composition. The reactive diluents of the invention preferably make up a proportion of up to 25% by weight, particularly preferably up to 20% by weight, in particular from 1 to 15% by weight, based on the entire curable composition.

The curable composition of the invention can also comprise, alongside 2,5-BAMF, other aliphatic, cycloaliphatic, and aromatic polyamines. It is preferable that 2,5-BAMF makes up at least 50% by weight, particularly at least 80% by weight, very particularly at least 90% by weight, based on the total weight of the amine hardeners in the curable composition. In one preferred embodiment, the curable composition comprises no other amine hardeners alongside 2,5-BAMF. For the purposes of the present invention, the expression amine hardener means an amine with NH functionality ≧2 (where by way of example a primary monoamine has NH functionality 2, a primary diamine has NH functionality 4, and an amine having 3 secondary amino groups has NH functionality 3).

Epoxy resins according to this invention usually have from 2 to 10, preferably from 2 to 6, very particularly preferably from 2 to 4, and in particular 2, epoxy groups. The epoxy groups are in particular the glycidyl ether groups that are produced in the reaction of alcohol groups with epichlorohydrin. The epoxy resins can be low-molecular-weight compounds which generally have an average molar mass (Mₙ) smaller than 1000 g/mol or relatively high-molecular-weight compounds (polymers). These polymeric epoxy resins preferably have a degree of oligomerization of from 2 to 25, particularly preferably from 2 to 10, units. They can be aliphatic or cycloaliphatic compounds, or compounds having aromatic groups. In particular, the epoxy resins are compounds having two aromatic or aliphatic 6-membered rings, or oligomers thereof. Epoxy resins important in industry are obtainable via reaction of epichlorohydrin with compounds which have at least two reactive hydrogen atoms, in particular with polyols. Particularly important epoxy resins are those obtainable via reaction of epichlorohydrin with compounds comprising at least two, preferably two, hydroxy groups and comprising two aromatic or aliphatic 6-membered rings. Compounds of this type that may in particular be mentioned are bisphenol A and bisphenol F, and also hydrogenated bisphenol A and bisphenol F—the corresponding epoxy resins being the diglycidyl ethers of bisphenol A or bisphenol F, or of hydrogenated bisphenol A or bisphenol F. Bisphenol A diglycidyl ether (DGEBA) is usually used as epoxy resin according to this invention. Other suitable epoxy resins according to this invention are tetraglycidylmethylenedianiline (TGMDA) and triglycidylaminophenol, and mixtures thereof. It is also possible to use reaction products of epichlorohydrin with other phenols, e.g. with cresols or with phenol-aldehyde adducts, for example with phenol-formaldehyde resins, in particular with novolaks. Other suitable epoxy resins are those which do not derive from epichlorohydrin. It is possible to use, for example, epoxy resins which comprise epoxy groups via reaction with glycidyl (meth)acrylate. It is preferable in the invention to use epoxy resins or mixtures thereof which are liquid at room temperature (25° C.). The epoxy equivalent weight (EEW) gives the average mass of the epoxy resin in g per mole of epoxy group.

It is preferable that the curable composition of the invention is composed of at least 50% by weight of epoxy resin.

In the curable composition of the invention it is preferable to use the compounds of the resin components (epoxy resins inclusive of any reactive diluents having their respective reactive groups) and amine hardeners in an approximately stoichiometric ratio based on the reactive groups of the compounds of the resin component (epoxy groups and, for example, any carbonate groups) and, respectively, NH functionality. Particularly suitable ratios of reactive groups of the compounds of the resin component to NH functionality are by way of example from 1:0.8 to 1:1.2. Reactive groups of the compounds of the resin component are those groups which, under the curing conditions, react chemically with the amino groups of the amino hardener(s).

The curable composition of the invention can also comprise other additions, for example inert diluents, curing accelerators, reinforcing fibers (in particular glass fibers or carbon fibers), pigments, dyes, fillers, release agents, tougheners, flow agents, antifoams, flame-retardant agents, or thickeners. It is usual to add a functional amount of these additions, an example being a pigment in an amount which leads to the desired color of the composition. The compositions of the invention usually comprise from 0 to 50% by weight, preferably from 0 to 20% by weight, for example from 2 to 20% by weight, of the entirety of all of the additives, based on the entire curable composition. For the purposes of this invention, the term additives means any of the additions to the curable composition which are neither epoxy compound nor reactive diluent nor amine hardener.

Formula I gives the molecular structure of 2,5-BAMF

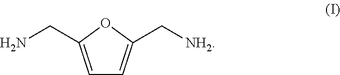

The present invention provides the use of 2,5-BAMF as hardener for resin components made of one or more epoxy resins and of one or more reactive diluents.

The present invention also provides the use of 2,5-BAMF as hardener for the production of epoxy-resin-based coatings, in particular floor coatings (flooring). It is preferable that these epoxy-resin-based coatings are produced with addition of reactive diluents to the epoxy resin.

The present invention also provides the use of 2,5-BAMF as hardener for the production of epoxy-resin-based coatings having early-stage water resistance, in particular floor coatings having early-stage water resistance. It is preferable that these epoxy-resin-based coatings are produced with addition of reactive diluents to the epoxy resin.

It is preferable that the coatings obtained in the invention have early-stage water resistance after as little as ≦20 h, in particular after ≦12 h.

By way of example, 2,5-BAMF can be produced by starting from 2,5-dimethylfuran (GB911221A, Ex. 4). 2,5-BAMF can also be produced from hydroxymethylfurfural, which in turn is obtainable from renewable raw materials (R. van Putten et al., Chemical Reviews (2013) 113 (3), 1499-1597). 2,5-BAMF therefore advantageously provides a hardener that can be obtained from renewable raw materials.

The invention further provides a process for the production of cured epoxy resins made of the curable composition of the invention. In the process of the invention for the production of these cured epoxy resins, the curable composition of the invention is provided and then cured. To this end, the components (epoxy resin component (made of epoxy resin and reactive diluent) and hardener component (comprising 2,5-BAMF) and optionally other components, for example additives) are brought into contact with one another and mixed, and then cured at a temperature that, in terms of the application, is practicable. The curing preferably takes place at a temperature of at least 0° C., particularly at least 10° C.

The invention particularly provides a process for the production of moldings, which comprises providing, charging to a mold, and then curing a curable composition of the invention. To this end, the components (epoxy resin component (made of epoxy resin and reactive diluent) and hardener component (comprising 2,5-BAMF) and optionally other components, for example additives) are brought into contact with one another and mixed, and charged to a mold, and then cured at a temperature that, in terms of the application, is practicable. The curing preferably takes place at a temperature of at least 0° C., particularly at least 10° C.

The invention particularly provides a process for the production of coatings, which comprises providing, applying to a surface, and then curing a curable composition of the invention. To this end, the components (epoxy resin component (made of epoxy resin and reactive diluent) and hardener component (comprising 2,5-BAMF) and optionally other components, for example additives) are brought into contact with one another and mixed, and applied to a surface, and then cured at a temperature that, in terms of the application, is practicable. The curing preferably takes place at a temperature of at least 0° C., particularly at least 10° C.

It is preferable that the cured epoxy resin is then subjected to thermal post-treatment, for example in the context of the curing process or in the context of optional subsequent heat-conditioning.

The curing process can take place at atmospheric pressure and at temperatures below 250° C., in particular at temperatures below 210° C., preferably at temperatures below 185° C., in particular in the temperature range from 0 to 210° C., very particularly preferably in the temperature range from 10 to 185° C.

The curing process takes place by way of example in a mold until dimensional stability has been achieved and the workpiece can be removed from the mold. The subsequent process for the dissipation of internal stresses within the workpiece and/or for completing the crosslinking of the cured epoxy resin is termed heat-conditioning. It is also possible in principle to carry out the heat-conditioning process before removal of the workpiece from the mold, for example in order to complete the crosslinking process. The heat-conditioning process usually takes place at temperatures on the limit of dimensional stiffness. It is usual to carry out heat-conditionings at temperatures of from 60 to 220° C., preferably at temperatures of from 80 to 220° C. The cured workpiece is usually subjected to the conditions of heat-conditioning for a period of from 30 to 600 min. Longer heat-conditioning times can also be appropriate, depending on the dimensions of the workpiece.

The invention also provides the cured epoxy resin made of the curable composition of the invention. In particular, the invention provides cured epoxy resin which is obtainable, or is obtained, via curing of a curable composition of the invention. The invention in particular provides cured epoxy resin which is obtainable, or is obtained, via the process of the invention for the production of cured epoxy resins.

The epoxy resins cured in the invention have comparatively high Tg.

The curable compositions of the invention are suitable as coating compositions or impregnating compositions, as adhesive, for the production of moldings and of composite materials, or as casting compositions for the embedding, binding, or consolidation of moldings. Coating compositions that may be mentioned are by way of example lacquers. In particular, the curable compositions of the invention can be used to obtain scratch-resistant protective lacquers on any desired substrates, e.g. made of metal or plastic, or of timber materials. The curable compositions are also suitable as insulating coatings in electronic applications, e.g. as insulating coating for wires and cables. Mention may also be made of the use for the production of photoresists. They are also suitable as rehabilitation lacquer, including by way of example in the in-situ renovation of pipes (cure in place pipe (CIPP) rehabilitation). They are particularly suitable for the coating or sealing of floors.

Composite materials (composites) comprise various materials, such as plastics and reinforcing materials (e.g. glass fibers or carbon fibers) bonded to one another.

Production processes that may be mentioned for composite materials are curing of preimpregnated fibers or of woven-fiber fabrics (e.g. prepregs) after storage, and also extrusion, pultrusion, winding, and infusion or injection processes such as vacuum infusion (VARTM), transfer molding (resin transfer molding, RTM), and also wet compression processes such as BMC (bulk mold compression).

The curable composition is suitable for the production of moldings, in particular of those using reinforcing fibers (e.g. glass fibers or carbon fibers).

The invention further provides moldings made of the cured epoxy resin of the invention, a coating, in particular floor coatings with early-stage water resistance) made of the cured epoxy resin, composite materials which comprise the cured epoxy resin of the invention, and also fibers impregnated with the curable composition of the invention. The composite materials of the invention preferably comprise glass fibers and/or carbon fibers, alongside the cured epoxy resin of the invention.

The invention further provides coatings which are obtainable, or are obtained, via coating of a surface with a curable composition which comprises, as components, 2,5-BAMF and one or more epoxy resins, and then curing of said composition. The coating thus obtainable, or thus obtained, is by way of example a floor coating. The coating thus obtainable, or thus obtained, has good early-stage water resistance. The early-stage water resistance of this coating is preferably achieved after as little as ≦20 h, in particular after ≦12 h, after mixing of the components. The coating thus obtainable, or thus obtained, exhibits rapid achievement of Shore D hardness. It is preferable that the Shore D hardness achieved is >45% after as little as ≦24 h.

The glass transition temperature (Tg) can be determined by means of dynamic-mechanical analysis (DMA), for example in accordance with the standard DIN EN ISO 6721, or by a differential calorimeter (DSC), for example in accordance with the standard DIN 53765. In the case of DMA, a rectangular test specimen is subjected to a torsion load with an imposed frequency and specified deformation. The temperature here is raised with a defined gradient, and storage modulus and loss modulus are recorded at fixed intervals. The former represents the stiffness of a viscoelastic material. The latter is proportional to the energy dissipated within the material. The phase shift between the dynamic stress and the dynamic deformation is characterized by the phase angle δ. The glass transition temperature can be determined by various methods: as maximum of the tan δ curve, as maximum of the loss modulus, or by means of a tangential method applied to the storage modulus. When the glass transition temperature is determined by use of a differential calorimeter, a very small amount of specimen (about 10 mg) is heated in an aluminum crucible, and the heat flux to a reference crucible is measured. This cycle is repeated three times. The glass transition is determined as average value from the second and third measurement. Tg can be determined from the heat-flux curve by way of the inflexion point, or by the half-width method, or by the midpoint temperature method.

The gel time provides, in accordance with DIN 16 945 information about the interval between addition of the hardener to the reaction mixture and the conversion of the reactive resin composition from the liquid state to the gel state. The temperature plays an important part here, and the gel time is therefore always determined for a predetermined temperature. By using dynamic-mechanical methods, in particular rotary viscometry, it is also possible to study small amounts of specimens quasi-isothermally and to record the entire viscosity curve or stiffness curve for these. In accordance with the standard ASTM D4473, the point of intersection of the storage modulus G′ and the loss modulus G″, at which the damping tan δ has the value 1 is the gel point, and the time taken, from addition of the hardener to the reaction mixture, to reach the gel point is the gel time. The gel time thus determined can be considered to be a measure of the hardening rate.

Early-stage water resistance is the property of a coating of permitting contact with water shortly after application, without damage to the coating. In the case of coatings based on epoxy resins and on amine hardeners this is in particular carbamate formation, which is discernible from formation of white haze or crusts on the surface of the fresh coating.

Shore hardness is a numerical indicator for polymers such as cured epoxy resins which is directly related to the penetration depth of an indenter into a test specimen, and it is therefore a measure of the hardness of the test specimen. It is determined by way of example in accordance with the standard DIN ISO 7619-1. A distinction is drawn between the Shore A, C, and D methods. The indenter used is a spring-loaded pin made of hardened steel. In the test, the indenter is forced into the test specimen by the force from the spring, and the penetration depth is a measure of Shore hardness. Determination of Shore hardness A and C uses, as indenter, a truncated cone with a tip of diameter 0.79 mm and an insertion angle of 35°, whereas the Shore hardness D test uses, as indenter, a truncated cone with a spherical tip of radius 0.1 mm and an insertion angle of 30°. The Shore hardness values are determined by introducing a scale extending from 0 Shore (penetration depth 2.5 mm) to 100 Shore (penetration depth 0 mm). The scale value 0 here corresponds to the maximum possible impression, where the material offers no resistance to penetration of the indenter. In contrast, the scale value 100 corresponds to very high resistance of the material to penetration, and practically no impression is produced. The temperature plays a decisive part in the determination of Shore hardness, and the measurements must therefore be carried out in accordance with the standard within a restrictive temperature range of 23° C.±2° C. In the case of floor coatings it is usually assumed that walking on the floor is possible when Shore D hardness is 45 or above.

2,5-BAMF is a superior alternative to conventional amine hardeners such as MXDA and is also readily obtainable from renewable raw materials. In particular in the case of use as hardener for resin components made of epoxy resin and reactive diluent, the resultant initial viscosities for the curable composition are advantageous, without any disadvantageous delay of hardening.

The use of 2,5-BAMF as hardener for epoxy resins advantageously also leads to good early-stage water resistance of the corresponding hardened epoxy resins. Furthermore, when 2,5-BAMF is used as hardener for epoxy resins the time required to reach a hardness (Shore D hardness) at which the hardened epoxy resin can be exposed to initial load is also comparatively short. The hardener is therefore particularly suitable for the production of floor coatings.

The nonlimiting examples below now provide further explanation of the invention.

### EXAMPLE 1

Production of the Curable Composition (Reactive Resin Composition) and Investigation of Reactivity Profile

Various epoxy resin components (A to C) were produced by mixing of epoxy resin (bisphenol A diglycidyl ether, Epilox A19-03, Leuna Harze, EEW 182) with reactive diluent (hexanediol bisglycidyl ether (Epilox P13-20, Leuna Harze), C₁₂-C₁₄-alkylglycidyl ether (Epilox P13-18, Leuna Harze) and, respectively, propylene carbonate (Huntsmann) in accordance with Table 1. Epoxy resin component D without addition of reactive diluent served as comparison.

TABLE 1
Compositions of epoxy resin components

| No. | Epoxy resin | Reactive diluent | EEW |
|---|---|---|---|
| A | Epilox A19-03 | hexanediol bisglycidyl ether | 179 |
| | (90 parts) | (10 parts) | |
| B | Epilox A19-03 | C₁₂-C₁₄-alkyl glycidyl ether | 189 |
| | (90 parts) | (10 parts) | |
| C | Epilox A19-03 | propylene carbonate | 145 |
| | (90 parts) | (10 parts) | |
| D | Epilox A19-03 | — | 182 |
| | (100 parts) | | |

The formulations to be compared with one another were produced via mixing of stoichiometric amounts of the amine hardener 2,5-BAMF with the various epoxy resin components, and were immediately investigated. For comparison, corresponding experiments were carried out with MXDA as amine hardener, this being structurally similar to 2,5-BAMF.

The rheological measurements used to investigate the reactivity profile of the cycloaliphatic amines with epoxy resins were carried out in a shear-stress-controlled plate-on-plate rheometer (MCR 301, Anton Paar) with plate diameter 15 mm and with 0.25 mm gap, at various temperatures.

Investigation 1a) comparison of the time required for the freshly produced reactive resin composition to reach viscosity 10 000 mPa's at a defined temperature. The measurement was made in rotation in the abovementioned rheometer at various temperatures (0° C., 10° C., 23° C., and 75° C.). At the same time, initial viscosity was determined for the respective mixtures (over the period from 2 to 5 min after mixing of the components) at the respective temperatures. Table 2 collates the results.

TABLE 2
Initial viscosity (Int. visc. in mPa's) and time (t
in min) for isothermal viscosity rise to 10 000 mPa's

| | 10° C. | | 23° C. | | 75° C. | |
|---|---|---|---|---|---|---|
| Composition (epoxy resin | Int. | | Int. | | Int. | |
| component and hardener) | visc. | t | visc. | t | visc. | t |
| A and 2,5-BAMF | 334 | 416 | 627 | 178 | 30 | 12 |
| B and 2,5-BAMF | 227 | 611 | 57 | 305 | 24 | 15 |
| C and 2,5-BAMF | 140 | 315 | 49 | 196 | 23 | 12 |
| D and 2,5-BAMF | 863 | 319 | 196 | 185 | 55 | 12 |
| A and MXDA | 2518 | 167 | 557 | 179 | 30 | 13 |
| B and MXDA | 1565 | 232 | 451 | 221 | 25 | 16 |
| C and MXDA | 159 | 291 | 371 | 125 | 23 | 12 |
| D and MXDA | 950 | 305 | 181 | 210 | 71 | 13 |

Investigation 1 b) comparison of gel times. The measurement was made in oscillation in the abovementioned rheometer at 0° C., 10° C., 23° C., and 75° C. The point of intersection of loss modulus (G″) and storage modulus (G′) provides the gel time. Table 3 collates the results.

TABLE 3
Isothermal gel times (in min)

| Composition (epoxy resin | | | | |
|---|---|---|---|---|
| component and hardener) | 0° C. | 10° C. | 23° C. | 75° C. |
| A and 2,5-BAMF | 2230 | 1100 | 430 | 16 |
| B and 2,5-BAMF | 3127 | 1249 | 496 | 18.5 |
| C and 2,5-BAMF | 2113 | 876 | 353 | 15 |
| D and 2,5-BAMF | 1755 | 968 | 334 | 16 |
| A and MXDA | 2668 | 1165 | 462 | 18 |
| B and MXDA | 2996 | 1446 | 565 | 21 |
| C and MXDA | 1685 | 782 | 355 | 17.5 |
| D and MXDA | 1713 | 1011 | 383 | 18 |

In most cases the gel point is reached more quickly in the case of the compositions cured by 2,5-BAMF than in the corresponding compositions cured by MXDA, although the viscosity of compositions cured by 2,5-BAMF is below 10 000 mPa's for a longer time, and these compositions therefore have a comparatively long period of good processability. Accordingly, the curable compositions based on 2,5-BAMF feature comparatively advantageous initial viscosity, and retain low viscosity (<10 000 mPa's) for a comparatively long time, but then require a comparatively short time to reach the gel point.

### EXAMPLE 2

Exothermic Profile of the Curable Composition (Reactive Resin Composition) and Glass Transition Temperatures of the Cured Epoxy Resins (Hardened Thermosets)

The DSC investigations of the curing reaction of 2,5-BAMF and, respectively, MXDA with epoxy resin components A to D in order to determine onset temperature (To), maximum temperature (Tmax), exothermic energy (ΔH), and glass transition temperatures (Tg) were carried out in accordance with ASTM D3418, and the temperature profile used here was as follows: 0° C.→5K/min 180° C.→30 min 180° C.→20K/min 0° C.→20K/min 220° C. In each case, 2 procedures were carried out, and Tg here was in each case determined in the 2^{nd} procedure. Table 4 collates the results.

TABLE 4
Exothermic profile and glass transition temperatures

| Composition (epoxy resin | To | ΔH | Tg |
|---|---|---|---|
| component and hardener) | (° C.) | (J/g) | (° C.) |
| A and 2,5-BAMF | 75.9 | 606 | 101 |
| B and 2,5-BAMF | 80.0 | 586 | 90 |
| C and 2,5-BAMF | 72.5 | 560 | 80 |
| D and 2,5-BAMF | 78.0 | 609 | 117 |
| A and MXDA | 75.0 | 629 | 108 |
| B and MXDA | 79.2 | 594 | 97 |
| C and MXDA | 71.7 | 554 | 84 |
| D and MXDA | 75 | 551 | 124 |

The glass transition temperatures achieved with BAMF are comparable with those achieved with MXDA, and the same applies to the various reductions of the glass transition temperatures caused by reactive diluents.

### EXAMPLE 3

Early-Stage Water Resistance and Development of Shore D Hardness

The early-stage water resistance of the thermosets made of hardener component (2,5-BAMF and, respectively, MXDA) and epoxy resin components (A to D) was investigated by mixing the two components in stoichiometric ratio in a high-speed mixer (1 min at 2000 rpm) pouring the mixture into a number of dishes, and storing it at 23° C. in a cabinet under controlled conditions (60% relative humidity). At regular intervals, in each case one dish was removed and the surface of the epoxy resin was treated with 2 ml of distilled water. The time required for the epoxy resin to exhibit no carbamate formation on contact with water, and thus to have achieved early-stage water resistance, was determined. Carbamate formation is discernible from development of crusts or white haze on the surface of the epoxy resin.

In order to investigate the development of Shore D hardness, the hardener component (2,5-BAMF and, respectively, MXDA) was in each case mixed in stoichiometric ratio with epoxy resin component D in a high-speed mixer (1 min at 2000 rpm), and the mixture was poured into a number of dishes. The dishes were then stored at 10° C. in a cabinet under controlled conditions (60% relative humidity), and the Shore D hardness of the test specimens (thickness 6 mm) was determined at regular intervals at 23° C. by means of a durometer (TI Shore test rig Sauter measurement technique). Table 5 collates the time required to reach Shore D hardness >45, and the Shore D hardness after 48 h of storage time. For all of the compositions investigated it was found that under the abovementioned conditions a plateau value for Shore D hardness had been reached within 48 h of storage. This Shore D hardness therefore corresponds to the maximum achievable Shore D hardness for the respective composition.

TABLE 5
Early-stage water resistance and Shore D hardness

| | t_{F} at | t_{SD45} at | SD after |
|---|---|---|---|
| Composition (epoxy resin | 23° C. | 10° C. | 48 h at |
| component and hardener) | (in h) | (in h) | 10° C. |
| A and 2,5-BAMF | 6 | | 87 |
| B and 2,5-BAMF | 8 | | 87 |
| C and 2,5-BAMF | 8 | | 87 |
| D and 2,5-BAMF | 8 | 19 | 92 |
| A and MXDA | 24 | | 88 |
| B and MXDA | 24 | | 89 |
| C and MXDA | 24 | | 92 |
| D and MXDA | >240 | 28 | 91 |

t_{F}: Time required to achieve early-stage water resistance;
t_{SD45}: time required to reach Shore D hardness >45;
SD: Shore D hardness

BAMF has excellent suitability as hardener for epoxy-resin-based floor coatings, because it provides not only early-stage water resistance but also hardness adequate for walking on the floor within a comparatively short time after the coating thereof.

1-17. (canceled)

18. A curable composition, which comprises:
a resin component and a hardener component,
wherein
the resin component comprises an epoxy resin and an reactive diluent, and
the hardener component comprises 2,5-bisaminomethylfuran.

19. The curable composition according to claim 18, wherein the reactive diluent is present in an amount of from 1 to 20% by weight, relative to the amount of the resin component of the curable composition.

20. The curable composition according to claim 18, wherein the reactive diluent comprises a low-molecular-weight organic compounds having at least one epoxy group or is a cyclic carbonate having from 3 to 10 carbon atoms.

21. The curable composition according to claim 18, wherein the reactive diluent comprises a cyclic carbonate having from 3 to 10 carbon atoms.

22. The curable composition according to claim 20, wherein the reactive diluent comprises at least one member selected from the group consisting of ethylene carbonate, vinylene carbonate, propylene carbonate, 1,4-butanediol bisglycidyl ether, 1,6-hexanediol bisglycidyl ether, glycidyl neodecanoate, glycidyl versatate, 2-ethylhexyl glycidyl ether, neopentyl glycol diglycidyl ether, p-tert-butyl glycidic ether, butyl glycidic ether, C₈-C₁₀-alkyl glycidyl ether, C₁₂-C₁₄-alkyl glycidyl ether, nonylphenyl glycidic ether, p-tert-butyl phenyl glycidic ether, phenyl glycidic ether, o-cresyl glycidic ether, polyoxypropylene glycol diglycidic ether, trimethylolpropane triglycidic ether, glycerol triglycidic ether, triglycidylpara-aminophenol, divinylbenzyl dioxide and dicyclopentadiene diepoxide.

23. The curable composition according to claim 21, wherein the reactive diluent comprises at least one member selected from the group consisting of ethylene carbonate, propylene carbonate, butylene carbonate, and vinylene carbonate.

24. The curable composition according to claim 18, wherein the epoxy resin comprises at least one member selected from the group consisting of diglycidyl ether of bisphenol A, diglycidyl ether of bisphenol F, diglycidyl ether of hydrogenated bisphenol A, and diglycidyl ether of hydrogenated bisphenol F.

25. A process for the production of a cured epoxy resin, which comprises curing a curable composition according to claim 18.

26. A process for the production of moldings, which comprises charging a mold with a curable composition according to claim 18, and then curing said curable composition.

27. A process for the production of a coating, which comprises applying a curable composition according to claim 18 to a surface, and then curing said curable composition present on said surface.

28. A cured epoxy resin which is obtained by a process according to claim 25.

29. A cured epoxy resin which is obtained by curing a curable composition according to claim 18.

30. A molding which is comprised of a cured epoxy resin according to claim 28.

31. A coating which is comprised of a cured epoxy resin according to claim 28.

32. A method of hardening an epoxy resin, comprising
adding 2,5-bisaminomethylfuran to a curable composition, said curable composition comprising a resin component, wherein the resin component comprises an epoxy resin and an reactive diluent; and thereafter,
curing the curable composition.
